(19) United States
(12) Patent Application Publication
(10) Pub. No.: US 2015/0052382 A1
(43) Pub. Date: Feb. 19, 2015

(54) FAILOVER METHODS AND SYSTEMS FOR A VIRTUAL MACHINE ENVIRONMENT

(71) Applicant: NETAPP, INC., Sunnyvale, CA (US)

(72) Inventors: Daniel Andrew Sarisky, Cary, NC (US); Jonathan Kenneth Rippy, Raleigh, NC (US); Dale Holloway, Raleigh, NC (US); Santosh C. Lolayekar, Saratoga, CA (US)

(73) Assignee: NETAPP, INC., Sunnyvale, CA (US)

(21) Appl. No.: 13/966,580

(22) Filed: Aug. 14, 2013

(51) Int. Cl. G06F 11/20; G06F 9/455

(52) U.S. Cl. CPC G06F 11/2025; G06F 9/455
USPC 714/4.11

(57) ABSTRACT

A storage provider executing a plurality of Web servers is provided for receiving a request from a management console managing a plurality of virtual machines. The management console uses a same address to send the request, regardless of which Web server is selected to process the request. The selected Web server re-sends the request to a second storage provider node instance, when a first storage provider node instance fails to process the request, where the first and the second storage provide node instances are executed by the storage provider as virtual machines for providing failover in processing requests.

### TECHNICAL FIELD

The present disclosure relates to storage systems in a virtual machine environment.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple users with access to shared data, backing up data and others.

A storage system typically includes at least one computing system executing a storage operating system for storing and retrieving data on behalf of one or more client computing systems (“clients”). The storage operating system stores and manages shared data containers in a set of mass storage devices.

Storage systems are being used extensively in virtual environments where a physical resource is time-shared among a plurality of independently operating processor executable virtual machines. Typically, storage space is presented to a virtual machine as a virtual hard disk (VHD) file. A storage drive is then presented to a user via a user interface within a virtual machine context. The user can use the storage drive to access storage space to read and write information. Continuous efforts are being made to better manage and utilize storage resources in a virtual machine environment.

### BRIEF DESCRIPTION OF THE DRAWINGS

The foregoing features and other features will now be described with reference to the drawings of the various embodiments. In the drawings, the same components have the same reference numerals. The illustrated embodiments are intended to illustrate, but not to limit the present disclosure. The drawings include the following Figures:

FIG. 1A shows an example of an operating environment for the various embodiments disclosed herein;

FIG. 1B shows an example of a storage provider, according to one embodiment;

FIG. 2A shows a block diagram of a clustered storage system, used according to one embodiment;

FIG. 2B shows an example of a data structure, used according to one embodiment;

FIGS. 2C-2D show various process flow diagrams, according to the various embodiments of the present disclosure;

FIG. 3 shows a storage node used in the cluster of FIG. 2A, according to one embodiment;

FIG. 4 shows an example of a storage operating system, used according to one embodiment; and

FIG. 5 shows an example of a processing system, used according to one embodiment.

### DETAILED DESCRIPTION

As preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device, in accordance with the claimed subject matter.

In one embodiment, a storage provider executing a plurality of Web servers is provided. One of the Web servers receives a request from a management console managing a plurality of virtual machines. The management console uses a same address to send the request, regardless of which Web server is selected to process the request. The selected Web server re-sends the request to a second storage provider node instance, when a first storage provider node instance fails to process the request, where the first and the second storage provide node instances are executed by the storage provider as virtual machines for providing failover in processing management console requests.

System 100

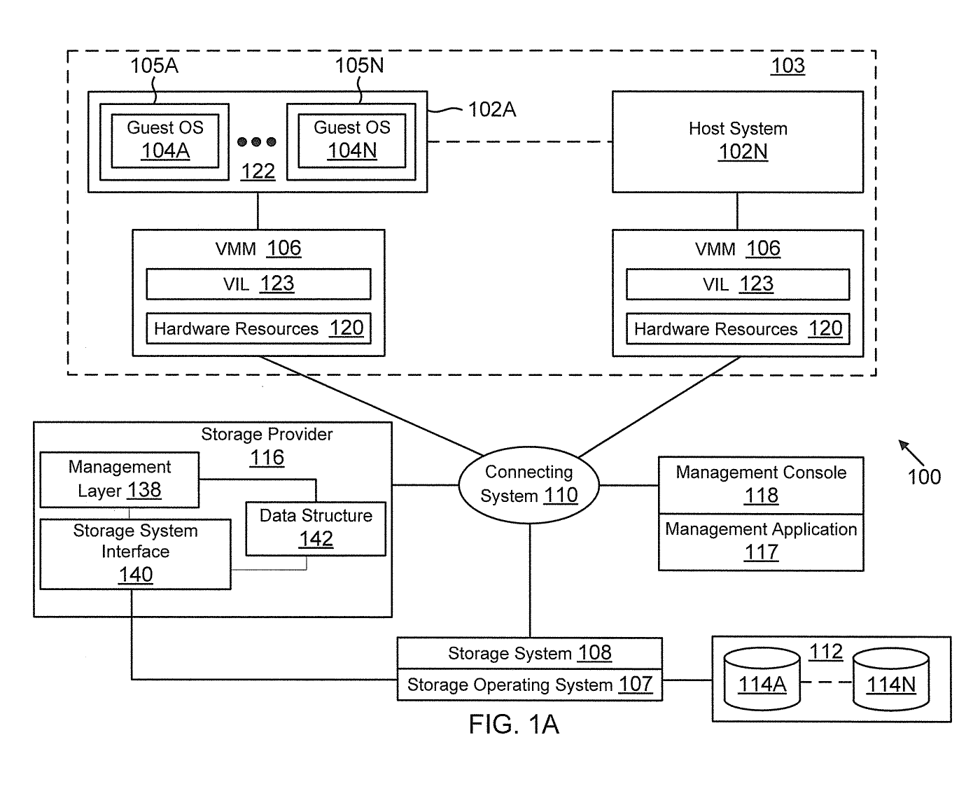

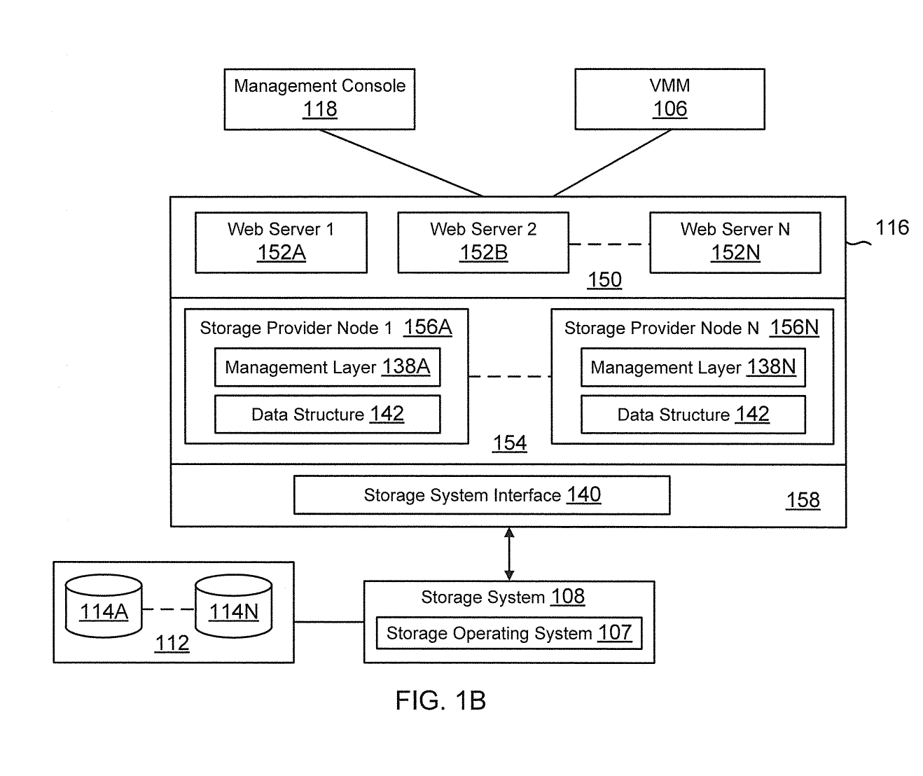

FIG. 1A shows an example of a system 100, where the adaptive embodiments disclosed herein may be implemented. System 100 includes a virtual machine environment where a physical resource is time-shared among a plurality of independently operating processor executable virtual machines (VMs). Each VM may function as a self-contained platform, running its own operating system (OS) and computer executable, application software. The computer executable instructions running in a VM may be collectively referred to herein as “guest software.” In addition, resources available within the VM may be referred to herein as “guest resources.”

The guest software expects to operate as if it were running on a dedicated computer rather than in a VM. That is, the guest software expects to control various events and have access to hardware resources on a physical computing system (may also be referred to as a host platform) which maybe referred to herein as “host hardware resources”. The host hardware resource may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host platform.

In one embodiment, system 100 may include a plurality of computing systems 102A-102N (may also be referred to as a host platform 102 or server 102) communicably coupled to a storage system 108 executing a storage operating system 107 via a management console 118 and/or a connection system 110 such as a local area network (LAN), wide area network (WAN), the Internet and others. As described herein, the term “communicably coupled” may refer to a direct connection, a network connection, or other connections to enable communication between devices. System 100 also includes a storage provider 116 that is described below in detail.

Host platform 102 includes a processor executable virtual execution environment 122 executing a plurality of VMs 105A-105N. VMs 105A-105N execute a plurality of guest OS 104A-104N (may also be referred to as guest OS 104) that share hardware resources 120. As described above, hardware resources 120 may include CPU, memory, I/O devices, storage or any other hardware resource.

In one embodiment, host platform 102 interfaces with a virtual machine monitor (VMM) 106 that includes, for example, a processor executed hypervisor layer provided by VMWare Inc., a Hyper-V layer provided by Microsoft Corporation of Redmond, Wash. or any other layer type. VMM 106 presents and manages the plurality of guest OS 104A-104N executed by the host platform 102. The VMM 106 may include or interface with a virtualization layer (VIL) 123 that provides one or more virtualized hardware resource to each OS 104A-104N.

In one embodiment, VMM 106 may be executed by host platform 102 with VMs 105A-105N. In another embodiment, VMM 106 may be executed by an independent stand-alone computing system, often referred to as a hypervisor server or VMM server and VMs 105A-105N are presented on another computing system. It is noteworthy that various vendors provide virtualization environments, for example, VMware Corporation, Microsoft Corporation and others. The generic virtualization environment described above with respect to FIG. 1A may be customized depending on the virtual environment provider.

System 100 may also include the management console 118 that executes a processor executable management application 117 for managing and configuring various elements of system 100. Management console 118 may be referred to as “Vcenter” in a virtual environment 103 provided by VMware Corporation. The management console 118 communicates with the host platforms, VMM 106 and storage provider 116 for managing storage presented to various VMs. For example, management application 117 may send a request to the storage provider 116 asking for storage space for a new VM; request enumeration of storage drives that are allocated for VMs; request storage attributes for storage space that is available and unassigned; request storage attributes for storage space that has been assigned and other similar requests. Such requests may be referred to herein as “management requests” or simply as client requests. Details regarding management console 118 operations are provided below.

In one embodiment, the storage provider 116 includes a management logic layer 138. The management layer 138 interfaces with VMM 106, storage system 108 and management console 118. The management logic layer 138 maintains a data structure 142 for managing access to storage space and for responding to management requests from management console 118 and/or VMM 106, as described below in detail. Information at data structure 142 may be based on storage information that is gathered by a storage system interface 140 from storage operating system 107. It is noteworthy that although management logic layer 138 and the storage system interface 140 are shown as separate modules, they may be integrated into a single module or segregated into more than two modules.

In one embodiment, the storage system 108 has access to a set of mass storage devices 114A-114N (may be referred to as storage devices 114) within at least one storage subsystem 112. The mass storage devices 114 may include writable storage device media such as magnetic disks, video tape, optical, DVD, magnetic tape, non-volatile memory devices for example, self-encrypting drives, flash memory devices and any other similar media adapted to store information. The storage devices 114 may be organized as one or more groups of Redundant Array of Independent (or Inexpensive) Disks (RAID). The embodiments disclosed are not limited to any particular storage device or storage device configuration.

The storage system 108 provides a set of storage volumes via connection system 110. The storage operating system 107 can present or export data stored at storage devices 110 as a volume, or one or more qtree sub-volume units to the storage provider 116 that can then present storage to management console 118 and/or VMM 106.

Each storage volume may be configured to store data files (or data containers or data objects), scripts, word processing documents, executable programs, and any other type of structured or unstructured data. From the perspective of one of the client systems, each volume can appear to be a single storage drive. However, each volume can represent the storage space in at one storage device, an aggregate of some or all of the storage space in multiple storage devices, a RAID group, or any other suitable set of storage space.

The storage devices or storage space at storage devices 114 may be presented as a “logical unit number” (LUN) where a LUN may refer to a logical data container that appears as a storage device to a host (client) but may be distributed across multiple storage devices of storage system 108.

Information regarding the storage devices 114 and the associated volumes may be stored at data structure 142. The information is collected and maintained by the storage system interface 140.

The storage system 108 may be used to store and manage information at storage devices 114 based on a request generated by a VM. The request may be based on file-based access protocols, for example, the Common Internet File System (CIFS) protocol or Network File System (NFS) protocol, over the Transmission Control Protocol/Internet Protocol (TCP/IP). Alternatively, the request may use block-based access protocols, for example, the Small Computer Systems Interface (SCSI) protocol encapsulated over TCP (iSCSI) and SCSI encapsulated over Fibre Channel (FCP).

In a typical mode of operation, a client (for example, a VM) transmits one or more input/output (I/O) commands, such as an NFS or CIFS request, over connection system 110 to the storage system 108. Storage system 108 receives the request, issues one or more I/O commands to storage devices 114 to read or write the data on behalf of the client system, and issues an NFS or CIFS response containing the requested data over the network 110 to the respective client system.

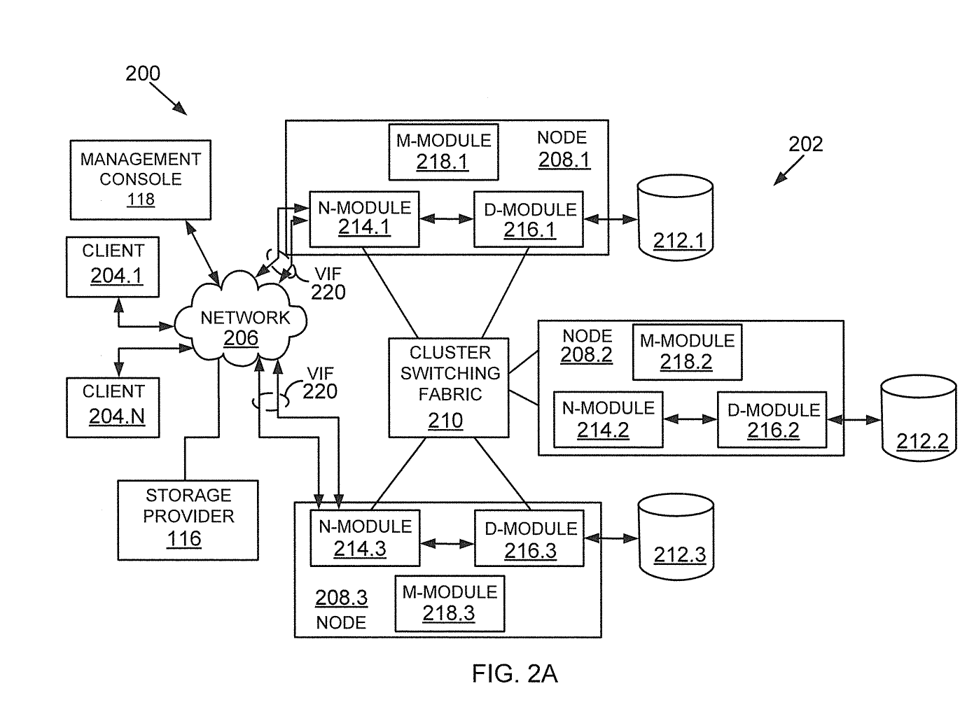

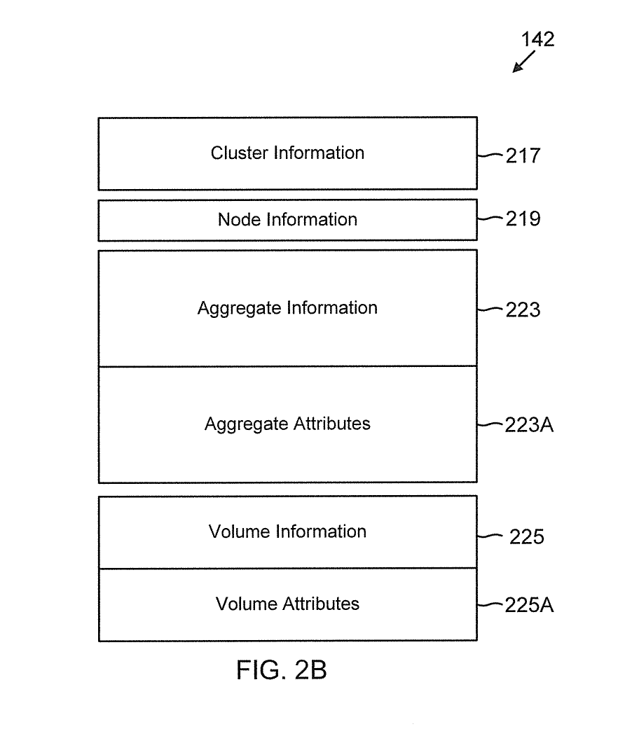

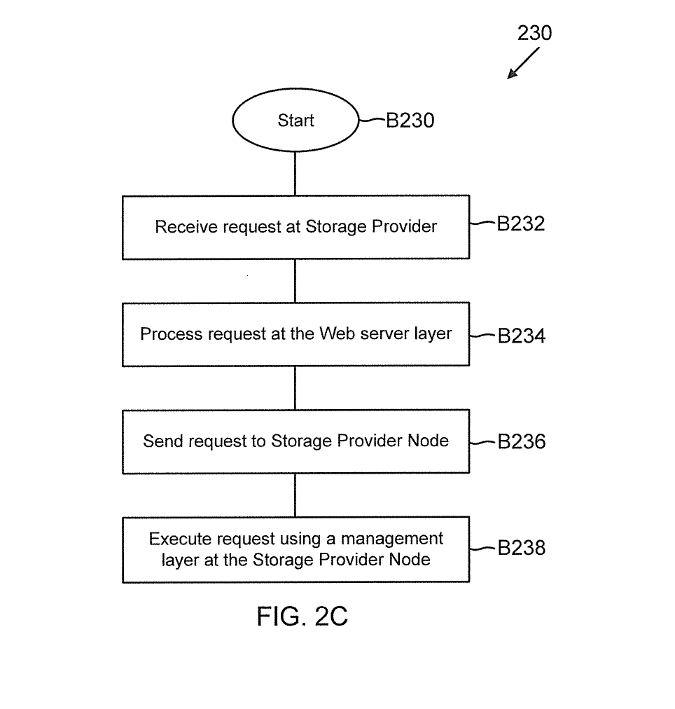

Although storage system 108 is shown as a stand-alone system, i.e. a non-cluster based system, in another embodiment, storage system 108 may have a distributed architecture; for example, a cluster based system that is described below in detail with respect to FIG. 2A.

FIG. 1B shows an example of an architecture for storage provider 116 for providing failover in processing requests from management console 118, VMM 106 or any other module of system 100. In the example of FIG. 1B, storage provider 116 may be a computing system similar to host system 102 and the various modules of storage provider 116 may be configured as virtual machines.

In one embodiment, storage provider 116 may be configured to have a plurality of layers, for example, a Web server layer 150 having a plurality of Web servers 152A-152N, a storage provider node layer 154 having a plurality of storage provider nodes 156A-156N and a persistence layer 158. Each Web server 152A-152N may use a protocol to interface with management console 118 and/or VMM 106, for example, the HTTP (hyper text transfer protocol) protocol. The Web servers 152A-152N are provided to maintain a connection with the management console 118 and/or VMM 106, receive a request from the management console 118 and/or VMM 106, forward the request to the storage provider layer 154 and then forward content in response to the request, as described below in detail.

When a request is received from the management console 118, it is routed to one of the storage provider nodes 156A-156N by one of the Web servers. As mentioned above, the request may be a management request for a configuration change, obtain storage attribute information or any other request type. Each storage provider node includes a management layer 138A-138N (similar to the management layer 138). In one embodiment, a storage provider node is an instance of storage provider 116. The storage provider nodes are provided for redundancy and failover. If one storage provider node is processing a request and if it fails, then the request is routed to another storage provider node.

In one embodiment, management application 117 may use a single Internet Protocol (IP) address to communicate with the storage provider 116. The management application 117 is unaware of multiple Web servers, multiple nodes or failure of any particular node, which means that the management application 117 assumes it is communicating with a single entity using the single IP address.

Storage system interface 140 of the persistence layer 158 regularly communicates with the storage system 108 for maintaining and updating storage information, for example, at data structure 142 for all storage provider nodes. Storage system interface 140 ensures that data structure is consistent regardless of which storage provider node in layer 154 is processing a request by periodically updating data structure 142. In one embodiment, an instance of data structure 142 is replicated across all the storage provider nodes in layer 154 to ensure consistency and integrity of information for all the storage provider nodes.

Clustered System

FIG. 2A shows a cluster based storage environment 200 having a plurality of storage system nodes for managing storage devices, according to one embodiment. Storage provider 116 interfaces with various nodes in the storage environment 200 via storage system interface 140 for maintaining data structures 142.

Storage environment 200 may include a plurality of client systems 204.1-204.N (or storage provider 116 or virtual machines 105A-105N), a clustered storage system 202 (similar to storage system 108) and at least a network 206 communicably connecting the client systems 204.1-204.N and the clustered storage system 202. As shown in FIG. 2A, the clustered storage system 202 includes a plurality of nodes 208.1-208.3, a cluster switching fabric 210, and a plurality of mass storage devices 212.1-212.3 (may be referred to as 212 and similar to storage device 114).

Each of the plurality of nodes 208.1-208.3 is configured to include an N-module, a D-module, and an M-Module, each of which can be implemented as a processor executable module. Specifically, node 208.1 includes an N-module 214.1, a D-module 216.1, and an M-Module 218.1, node 208.2 includes an N-module 214.2, a D-module 216.2, and an M-Module 218.2, and node 208.3 includes an N-module 214.3, a D-module 216.3, and an M-Module 218.3. Thus, the storage system nodes of FIG. 2A are different from the storage provider nodes of FIG. 1B described above.

The N-modules 214.1-214.3 include functionality that enable the respective nodes 208.1-208.3 to connect to the storage provider 116 and one or more of the client systems 204.1-204.N over the computer network 206, while the D-modules 216.1-216.3 connect to one or more of the storage devices 212.1-212.3. Accordingly, each of the plurality of nodes 208.1-208.3 in the clustered storage server arrangement provides the functionality of a storage server.

The M-Modules 218.1-218.3 provide management functions for the clustered storage system 202. The M-Modules 218.1-218.3 collect storage information regarding storage devices 212 and makes it available to storage provider 116, according to one embodiment. The information includes aggregate information, volume information, and volume attributes and features that may be enabled on a volume, for example, de-duplication, data protection, data mirroring, backup and other features.

A switched virtualization layer including a plurality of virtual interfaces (VIFs) 220 is provided to interface between the respective N-modules 214.1-214.3 and the client systems 204.1-204.N, allowing storage 212.1-212.3 associated with the nodes 208.1-208.3 to be presented to the client systems 204.1-204.N as a single shared storage pool.

Each of the nodes 208.1-208.3 is defined as a computing system to provide application services to one or more of the client systems 204.1-204.N. The nodes 208.1-208.3 are interconnected by the switching fabric 210, which, for example, may be embodied as a switch or any other type of connecting device.

Although FIG. 2A depicts an equal number (i.e., 3) of the N-modules 214.1-214.3, the D-modules 216.1-216.3, and the M-Modules 218.1-218.3, any other suitable number of N-modules, D-modules, and M-Modules may be provided. There may also be different numbers of N-modules, D-modules, and/or M-Modules within the clustered storage system 202. For example, in alternative embodiments, the clustered storage system 202 may include a plurality of N-modules and a plurality of D-modules interconnected in a configuration that does not reflect a one-to-one correspondence between the N-modules and D-modules.

A client may request the services of one of the respective nodes 208.1, 208.2, 208.3, and that node may return the results of the services requested by the client system by exchanging packets over the computer network 206, which may be wire-based, optical fiber, wireless, or any other suitable combination thereof. The client systems 204.1-204.N may issue packets according to file-based access protocols, such as the NFS or CIFS protocol, when accessing information in the form of files and directories.

FIG. 2B shows an example of a hierarchical data structure 142 used by storage provider 116 for responding to management requests from management console 118 and/or VMM 106. At a top-level, data structure 142 stores cluster information 217. Cluster information may be for cluster 200 and may include an identifier identifying the cluster, the different nodes within the cluster, protocols used within the cluster and any other information regarding the cluster.

Below, the cluster level, data structure 142 includes node information 219 that may be used to store information regarding the various cluster nodes, for example, 208.1-208.3. The node information identifies the nodes, the storage devices that are assigned to each node and any other information.

Data structure 142 also stores information regarding aggregates (aggregate information 223) within cluster 200. Each aggregate is a logical structure that includes a plurality of storage volumes and is uniquely identified. Aggregate information 223 identifies each aggregate and stores aggregate attributes 223A. Aggregate information 223 may identify each storage volume within each aggregate and any other aggregate related information.

Data structure 142 also stores volume information 225 and the attributes for each volume as 225A. Volume information may include an identifier that identifies the volume, information regarding a node that manages the volume, aggregate identifier to which the volume may belong and any other information. Volume attribute information 225A may store information regarding permissions associated with the volume, features that are enabled or can be enabled on the volume, for example, de-duplication, data mirroring, data security and other features. The attributes are set up when a volume is configured and may be changed by a user.

FIG. 2C shows a process 230 for processing a request by the storage provider 116, according to one embodiment. The process begins in block B230 when storage provider 116, management console 118, VM 106 and a plurality of VM are operational.

In block B232, a request is received at storage provider 116 from the management console 118 (and/or VMM 106). The request may be for obtaining information regarding storage space, making a configuration change, request for storage space or any other management related task. In one embodiment, VMM 106 may send a request for storage space for a VM to the management console 118 and the management console 118 then sends the request to the storage provider 116. The embodiments described herein are not limited to any particular request type. The request is received at the Web server layer 150 that maintains communication with management console 118.

In block B236, one of the Web servers 152A-152N is assigned to the request or the request is allocated to one of the Web servers. The Web server may be selected by a “master” Web server or a controller (not shown) of layer 150. The selected Web server then selects one of the storage provider nodes 156A-156N and the request is sent to the selected storage provider node in block B236. The storage provider node may be selected based on load balancing. For example, if Node 1 156A is already processing X requests, then the request from block B232 is sent to, for example, Node II 156B. In one embodiment, the Web server layer 150 tracks which node is processing how many requests at any given time. This information may be stored at a data structure (not shown) for layer 150.

In block B238, the request is executed by the management layer 138 and a response is provided to management console 118 by the Web server layer. If the request was to obtain information, then the management layer 138 reads the information from data structure 142 and the information is provided to the management console 118. If the request was to to make a configuration change, for example, to enable a storage attribute or disable a storage attribute, then the management layer 138 interfaces with the storage operating system 107 and requests the configuration change. The storage operating system 107 makes the configuration change and provides a status to the management layer 138 that updates data structure 142. A response is then provided to the management console 118 via the Web server layer 150.

FIG. 2D shows process 240 for handling errors in responding to a request from management console 118 and/or VMM 106, according to one embodiment. The process begins in block B241, when the storage provider 116, management console 118 and the other modules of system 100 are operational. In block B242, a management request is received by the Web layer 150 of storage provider 118. The request is allocated (or assigned) to one of the Web servers 152A-152N.

In block B244, one of the Web servers of the Web server layer 150 forwards the request to a storage provider node from among 156A-156N, for example, Node I 156A.

In block B246, Web server layer 150 detects an error or failure of Node I in processing the request. The error may be detected, when the Web server interfacing with the management console 118 does not receive an appropriate response for the request from Node I 156A within a given duration. The Web server may maintain a timer (not shown) to track the duration for receiving the response.

In block B248, the Web server layer 150 sends the request to another node, for example, Node II that processes the request in block B250. Thereafter, a Web server of the Web layer 150 sends a response to the requester that generated the request in block B242. As mentioned above, different request types may be received from management console 118 and hence, the response will depend on the nature of the request received in block B242.

It is noteworthy that the requester (i.e. management console 118) is unaware of the failure of Node I and that Node II processed the request. For the requester, storage provider 116 is a single, unified entity that is addressed by a single IP address.

In one embodiment, a method and system is provided that allows the storage provider 116 to process client requests even if a particular instance of the storage provider fails.

Storage System Node

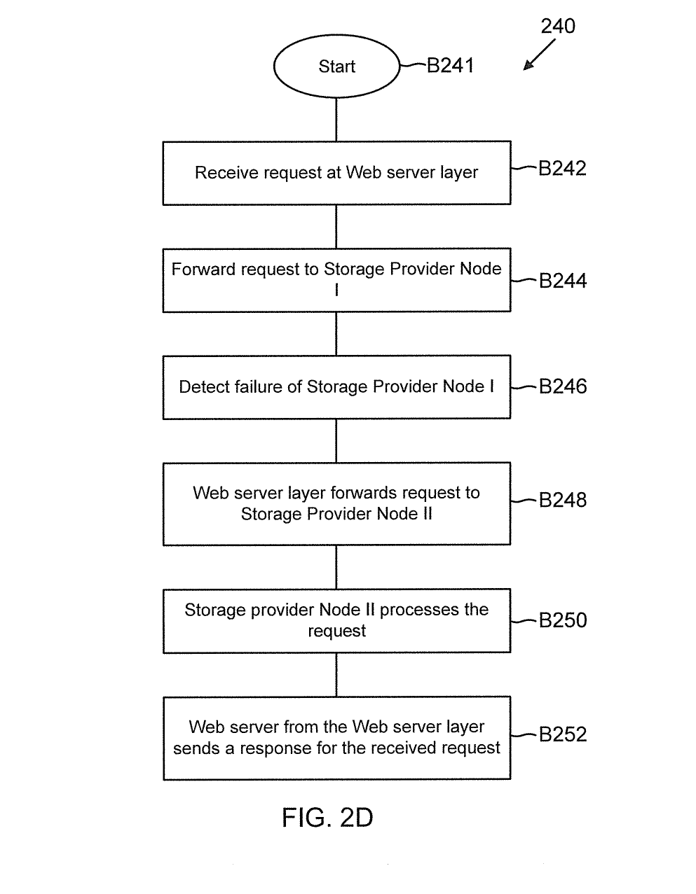

FIG. 3 is a block diagram of a node 208.1 that is illustratively embodied as a storage system comprising of a plurality of processors 302A and 302B, a memory 304, a network adapter 310, a cluster access adapter 312, a storage adapter 316 and local storage 313 interconnected by a system bus 308. Node 208.1 may be used to provide information regarding various storage devices 212 to storage provider 116, as described below.

Processors 302A-302B may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware devices. The local storage 313 comprises one or more storage devices utilized by the node to locally store configuration information for example, in a configuration data structure 314.

The cluster access adapter 312 comprises a plurality of ports adapted to couple node 208.1 to other nodes of cluster 100. In the illustrative embodiment, Ethernet may be used as the clustering protocol and interconnect media, although it will be apparent to those skilled in the art that other types of protocols and interconnects may be utilized within the cluster architecture described herein. In alternate embodiments where the N-modules and D-modules are implemented on separate storage systems or computers, the cluster access adapter 312 is utilized by the N/D-module for communicating with other N/D-modules in the cluster 100.

Each node 208.1 is illustratively embodied as a dual processor storage system executing a storage operating system 306 (similar to 107, FIG. 1A) that preferably implements a high-level module, such as a file system, to logically organize the information as a hierarchical structure of named directories and files on storage 212.1. However, it will be apparent to those of ordinary skill in the art that the node 208.1 may alternatively comprise a single or more than two processor systems. Illustratively, one processor 302A executes the functions of the N-module 104 on the node, while the other processor 302B executes the functions of the D-module 106.

The memory 304 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions pertaining to the presented disclosure.

The storage operating system 306 portions of which is typically resident in memory and executed by the processing elements, functionally organizes the node 208.1 by, inter alia, invoking storage operation in support of the storage service implemented by the node.

The network adapter 310 comprises a plurality of ports adapted to couple the node 208.1 to one or more clients 204.1/204.N over point-to-point links, wide area networks, virtual private networks implemented over a public network (Internet) or a shared local area network. The network adapter 310 thus may comprise the mechanical, electrical and signaling circuitry needed to connect the node to the network. Illustratively, the computer network 206 may be embodied as an Ethernet network or a Fibre Channel network. Each client 204.1/204.N may communicate with the node over network 206 by exchanging discrete frames or packets of data according to pre-defined protocols, such as TCP/IP.

The storage adapter 316 cooperates with the storage operating system 306 executing on the node 208.1 to access information requested by clients. The information may be stored on any type of attached array of writable storage device media such as video tape, optical, DVD, magnetic tape, bubble memory, electronic random access memory, micro-electro mechanical and any other similar media adapted to store information, including data and parity information. However, as illustratively described herein, the information is preferably stored on storage device 212.1. The storage adapter 316 comprises a plurality of ports having input/output (I/O) interface circuitry that couples to the storage devices over an I/O interconnect arrangement, such as a conventional high-performance, FC link topology.

Operating System

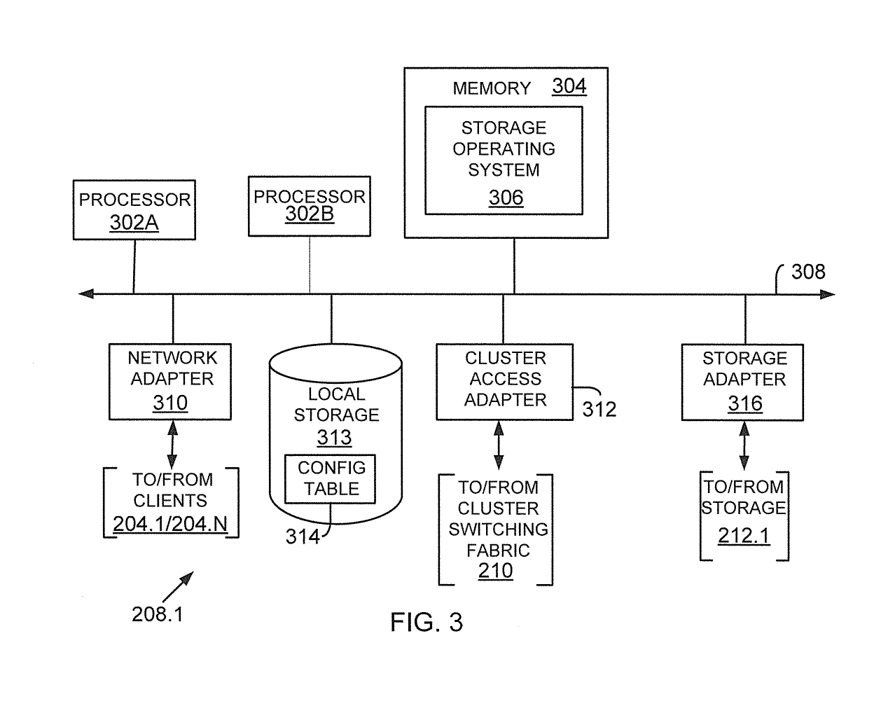

FIG. 4 illustrates a generic example of storage operating system 306 (or 107, FIG. 1A) executed by node 208.1, according to one embodiment of the present disclosure. The storage operating system 306 maintains information regarding various storage devices, storage volumes, LUNs, aggregates and others. The information is provided to storage provider 116 for data structures 142, as described above in detail.

In one example, storage operating system 306 may include several modules, or “layers” executed by one or both of N-Module 214 and D-Module 216. These layers include a file system manager 400 that keeps track of a directory structure (hierarchy) of the data stored in storage devices and manages read/write operation, i.e. executes read/write operation on storage in response to client requests.

Storage operating system 306 may also include a protocol layer 402 and an associated network access layer 406, to allow node 208.1 to communicate over a network with other systems, such as storage provider 116. Protocol layer 402 may implement one or more of various higher-level network protocols, such as NFS, CIFS, Hypertext Transfer Protocol (HTTP), TCP/IP and others, as described below.

Network access layer 406 may include one or more drivers, which implement one or more lower-level protocols to communicate over the network, such as Ethernet. Interactions between clients' and mass storage devices 212.1 are illustrated schematically as a path, which illustrates the flow of data through storage operating system 306.

The storage operating system 306 may also include a storage access layer 404 and an associated storage driver layer 408 to allow D-module 216 to communicate with a storage device. The storage access layer 404 may implement a higher-level storage protocol, such as RAID (redundant array of inexpensive disks), while the storage driver layer 408 may implement a lower-level storage device access protocol, such as FC or SCSI. The storage driver layer 408 may maintain various data structures (not shown) for storing information LUN, storage volume, aggregate and various storage devices.

As used herein, the term “storage operating system” generally refers to the computer-executable code operable on a computer to perform a storage function that manages data access and may, in the case of a node 208.1, implement data access semantics of a general purpose operating system. The storage operating system can also be implemented as a microkernel, an application program operating over a general-purpose operating system, such as UNIX® or Windows XP®, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly-attached to a client or host computer. The term “storage system” should therefore be taken broadly to include such arrangements in addition to any subsystems configured to perform a storage function and associated with other equipment or systems. It should be noted that while this description is written in terms of a write any where file system, the teachings of the present disclosure may be utilized with any suitable file system, including a write in place file system.

Processing System

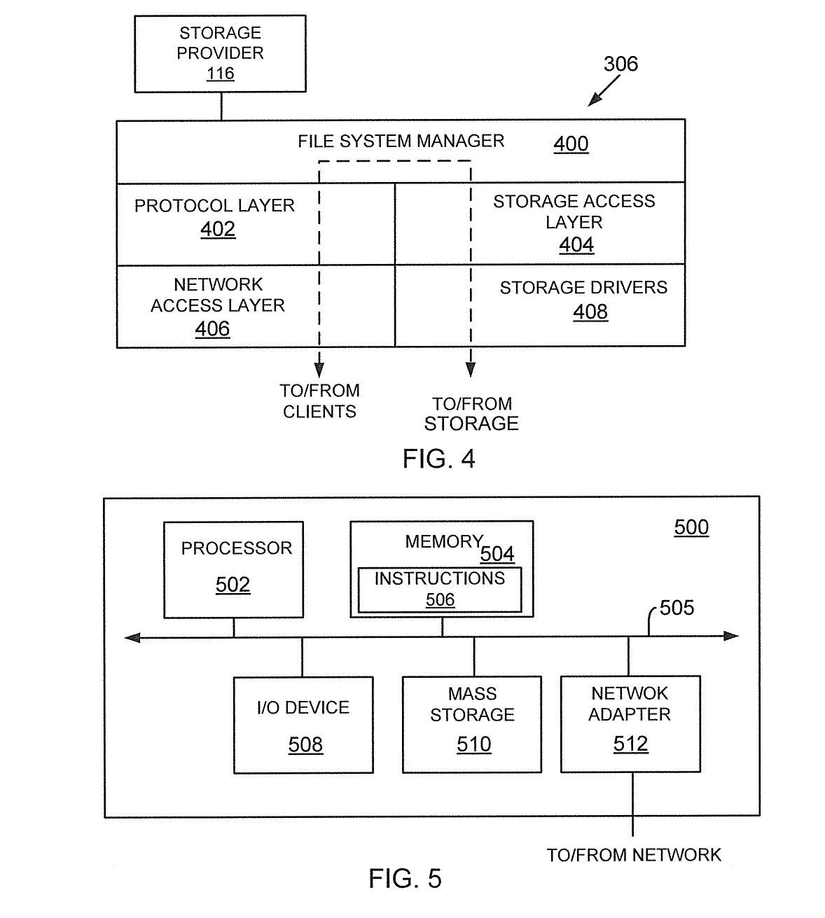

FIG. 5 is a high-level block diagram showing an example of the architecture of a processing system 500 that may be used according to one embodiment. The processing system 500 can represent storage provider 116, management console 118, host 102, or storage system 108. Note that certain standard and well-known components which are not germane to the present disclosure are not shown in FIG. 5.

The processing system 500 includes one or more processor(s) 502 and memory 504, coupled to a bus system 505. The bus system 505 shown in FIG. 5 is an abstraction that represents any one or more separate physical buses and/or point-to-point connections, connected by appropriate bridges, adapters and/or controllers. The bus system 505, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor(s) 502 are the central processing units (CPUs) of the processing system 500 and, thus, control its overall operation. In certain embodiments, the processors 502 accomplish this by executing software stored in memory 504. A processor 502 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 504 represents any form of random access memory (RAM), read-only memory (ROM), flash memory, or the like, or a combination of such devices. Memory 504 includes the main memory of the processing system 500. Instructions 506 implement the process steps described above with respect to FIGS. 2C-2D may reside in and execute (by processors 502) from memory 504.

Also connected to the processors 502 through the bus system 505 are one or more internal mass storage devices 510, and a network adapter 512. Internal mass storage devices 510 may be, or may include any conventional medium for storing large volumes of data in a non-volatile manner, such as one or more magnetic or optical based disks. The network adapter 512 provides the processing system 500 with the ability to communicate with remote devices (e.g., storage servers) over a network and may be, for example, an Ethernet adapter, a Fibre Channel adapter, or the like.

The processing system 500 also includes one or more input/output (I/O) devices 508 coupled to the bus system 505. The I/O devices 508 may include, for example, a display device, a keyboard, a mouse, etc.

Cloud Computing

The system and techniques described above are applicable and useful in the upcoming cloud computing environment. Cloud computing means computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” is intended to refer to the Internet and cloud computing allows shared resources, for example, software and information to be available, on-demand, like a public utility.

Typical cloud computing providers deliver common business applications online which are accessed from another Web service or software like a Web browser, while the software and data are stored remotely on servers. The cloud computing architecture uses a layered approach for providing application services. A first layer is an application layer that is executed at client computers. In this example, the application allows a client to access storage via a cloud.

After the application layer, is a cloud platform and cloud infrastructure, followed by a “server” layer that includes hardware and computer software designed for cloud specific services. The storage provider 116(and associated methods thereof) and storage systems described above can be a part of the server layer for providing storage services. Details regarding these layers are not germane to the inventive embodiments.

Thus, a method and apparatus for failover have been described. Note that references throughout this specification to “one embodiment” or “an embodiment” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics being referred to may be combined as suitable in one or more embodiments of the disclosure, as will be recognized by those of ordinary skill in the art.

While the present disclosure is described above with respect to what is currently considered its preferred embodiments, it is to be understood that the disclosure is not limited to that described above. To the contrary, the disclosure is intended to cover various modifications and equivalent arrangements within the spirit and scope of the appended claims.

What is claimed is:

1. A machine implemented method comprising:
receiving a request at a storage provider interfacing with a storage system that maintains storage space and a management console; wherein the request is a management request associated with management of the storage space;
assigning the request to a Web server from among a plurality of Web servers executed by the storage provider;
sending the request to a first storage provider node instance executed by the storage provider from among a plurality of storage provider node instances;
re-sending the request by the Web server to a second storage provider node instance when the first storage provider node instance fails to execute the request; and
executing the request by the second storage provider node, while the management console is unaware as to which storage provider node executes the request.

2. The method of claim 1, wherein the management console sends the request to the storage provider using a single address.

3. The method of claim 2, wherein the address is an Internet Protocol address.

4. The method of claim 1, wherein a first layer of the storage provider executes the plurality of Web servers and a second layer executes the plurality of storage provider node instances.

5. The method of claim 4, wherein each node instance of the plurality of storage provider node instances operates as an identical virtual machine interfacing with a third layer that interfaces with a storage operating system of the storage system for obtaining information regarding the storage space.

6. The method of claim 5, wherein the storage system is a clustered storage system having a plurality of nodes executing portions of the storage operating system in a distributed environment.

7. A machine implemented method, comprising:
executing a plurality of Web servers by a storage provider for receiving a request from a management console;
wherein the request is a management request associated with management of a storage space maintained by a storage system; and
sending the request to a second storage provider node instance, when a first storage provider node instance fails to process the request; wherein the first and the second storage provide node instances are executed by the storage provider for providing failover in processing the request; and wherein the management console uses a same address to send the request, regardless of which Web server is selected to forward the request to the second storage provider node.

8. The method of claim 7, wherein the request is to obtain storage space attribute information.

9. The method of claim 7, wherein the address is an Internet Protocol address.

10. The method of claim 7, wherein a first layer of the storage provider executes the plurality of Web servers and a second layer executes the plurality of storage provider node instances.

11. The method of claim 7, wherein each node instance of the plurality of storage provider node instances operates as an identical virtual machine interfacing with a third layer that interfaces with a storage operating system of the storage system for executing the request.

12. The method of claim 11, wherein the storage system is a clustered storage system having a plurality of nodes executing portions of the storage operating system in a distributed environment.

13. A system, comprising:
a storage provider module executing a plurality of Web servers for receiving a request from a management console; and executing at least a first storage provider node instance and a second provider node instance for providing failover in processing the request from the management console;
wherein the request is a management request associated with management of a storage space maintained by a storage system;
wherein one of the Web servers sends the request to the second storage provider node instance, when the first storage provider node instance fails to process the request; and
wherein the management console uses a same address to send the request, regardless of which Web server is selected to forward the request to the second storage provider node.

14. The system of claim 11, wherein the request is to obtain storage space attribute information.

15. The system of claim 11, wherein the address is an Internet Protocol address.

16. The system of claim 11, wherein a first layer of the storage provider executes the plurality of Web servers and a second layer executes the first and the second storage provider node instances.

17. The system of claim 11, wherein each node instance interfaces with a third layer that interfaces with a storage operating system for the storage system for executing the request.

18. The system of claim 15, wherein the request from the management console is based on a request from a virtual machine monitor for allocating storage to a virtual machine.

19. The system of claim 15, wherein the storage system is a clustered storage system having a plurality of nodes executing portions of the storage operating system in a distributed environment.

20. The system of claim 17, wherein the third layer executes a storage system interface that updates data structures for the first storage provider node instance and the second storage provider node instance for processing the request.
